(19) United States
(12) Patent Application Publication
(10) Pub. No.: US 2011/0135951 A1
(43) Pub. Date: Jun. 9, 2011

(54) METHOD OF PRESERVING HIDES AND SKINS

(75) Inventor: Peter J. Holicza, Vancouver (CA)

(73) Assignee: LEATHERTEQ LIMITED, Hong Kong (HK)

(21) Appl. No.: 12/523,240

(22) PCT Filed: Apr. 17, 2008
(86) PCT No.: PCT/CA08/00729

§ 371 Date: Jul. 15, 2009

Related U.S. Application Data
(60) Provisional application No. 61/032,847, filed on Feb. 29, 2008.

(51) Int. Cl. B32B 9/02; C14C 9/02

(52) U.S. Cl. 428/540; 8/94.16

(57) ABSTRACT

A method for preserving hides, skins and pelts prior to tanning, without salt-curing. The preliminary steps of washing, fleshing, liming, unhairing, deliming and bating the hides are followed by the steps of fatliquoring, pickling and drying. The method avoids the environmental damage cause by salt-curing. The treated hides are dry, flexible and readily rehydrated for further processing.

### TECHNICAL FIELD

The invention pertains to the preservation of hides, skins and pelts, and in particular to methods of preservation prior to tanning.

### BACKGROUND

The process of manufacturing leather from hides has changed relatively little for many years, and the many steps that comprise the process are well known in the industry. In general terms, there are preliminary steps to preserve the hides and prepare them for tanning, followed by the steps of tanning and further processing. The typical sequence of steps in the preliminary, pre-tanning part of the process is curing with salt (sodium chloride), soaking and washing, defleshing, liming, unhairing, bating and pickling.

The salt-curing of the hides, done as the first step, is carried out either by immersing the hides in a brine solution, by wet salting or by dry salting. The purpose of salt-curing is to retard spoilage prior to carrying out the remainder of the leather-making process. It is common in North America and many other parts of the world for hides to be preserved by salt-curing and then be shipped to overseas tanneries for the further processing and tanning.

Another common method of curing hides includes processing through the preliminary steps in the conventional manner and tanning with chromium sulphate, which results in a product termed wet blue, which is then further tanned, again, often at overseas tanneries. Even with this process, however, salt-curing may be done as a preliminary step.

The practice of salt-curing causes significant environmental damage. When the curing and the tanning are done at different facilities, this damage occurs in both places.

It would be desirable to be able to preserve hides prior to tanning without the use of salt-curing.

### SUMMARY OF THE INVENTION

The invention provides a method for preserving hides prior to tanning, in which the hides are subjected to preliminary steps comprising washing, fleshing, liming, unhairing, deliming and bating, characterized in that the process comprises the steps, after the step of bating, of fatliquoring, pickling and lastly drying. Optionally, the preliminary steps may include splitting the hide.

According to one embodiment, the step of fatliquoring is done before the step of pickling. The fatliquor may be an anionic fatliquor.

According to another embodiment, the step of fatliquoring is done after the step of pickling. The fatliquor may be a cationic fatliquor.

According to another embodiment, the step of fatliquoring comprises a first step of fatliquoring with an anionic fatliquor and a second step of fatliquoring with a cationic fatliquor, and the step of pickling is done between this first and second step of fatliquoring.

The invention further provides a preserved, fatliquored, untanned hide. The hide may also be pickled or unhaired, or both. It may be made according to the method of the invention.

It will be understood that the method of the present invention is a significant departure from conventional leather-making processes. Most importantly, the initial step of salt-curing of the hides is not required or done. The step of fatliquoring is carried out prior to any tanning of the hide, whereas in conventional processes it is generally done after the hide is tanned, not before. Also, the hide is dried after pickling, whereas in conventional processes, pickled hides are not dried prior to tanning.

The treated hides produced by the method of the invention are dry, flexible and readily rehydrated for further processing. They are easier to grade than hair-on, salted hides. They are much lighter in weight than salt-cured hides and therefore cheaper to ship. They do not include the waste by-products and the salt, present in salted hides, and therefore do not create disposal problems for the tanners.

These and other features of the invention will be apparent from the following description of the preferred embodiments.

### DESCRIPTION OF THE PREFERRED EMBODIMENTS

In this specification and claims, the term “hide” is to be understood as including hides, skins and pelts. It is also to be understood that all weight percentages stated herein, unless otherwise specified, are relative to the weight of the hide being treated. Thus, for example, reference to fatliquoring with a fatliquor that is 5 weight % refers to the weight percent of the fatliquor relative to the weight of the hide being fatliquored.

In carrying out the method of the invention, the hides are first prepared by means of the preliminary steps of washing, fleshing, liming, unhairing, optionally splitting, deliming and bating. Each of these steps is well understood in the art of hide processing. In method of the present invention, the steps would typically be carried out in the order listed.

The key steps of the method of the invention, carried out on the bated hide after the foregoing preliminary steps, are the steps of fatliquoring, pickling and drying. Drying is done as the last of these three steps. Fatliquoring can either precede or follow pickling, or both precede and follow it, and additional optional steps can be included in the method, all as explained below.

### Fatliquoring

Fatliquors are agents that lubricate, soften or make more flexible or pliable the fibers of hides or leathers. The application of such an agent is referred to herein as fatliquoring. Both anionic and cationic fatliquors can be used in the method of the invention. Nonionic fatliquors may also be used but anionic and cationic ones are preferred. Fatliquoring the hides is done in an aqueous solution of the fatliquor. Fatliquoring is done at concentrations of fatliquor from about 1 to 15 weight %, preferably 2 to 10 weight %, more preferably 5 to 10 weight % (relative to the weight of the hides being fatliquored). Processing times are in the range of 40 to 180 minutes. Preferred pH ranges are between 1 and 10, depending on the fatliquor used, and solution temperature ranges are between 25 and 60 degrees C.

When only an anionic fatliquor is used, the step of pickling is done after fatliquoring. Thus, one combination of steps in the method is: anionic fatliquoring, pickling and drying, in that order.

When only a cationic fatliquor is used, the step of pickling is done before fatliquoring. Thus, an alternative combination of steps in the method is: pickling, cationic fatliquoring and drying, in that order.

Both anionic and cationic fatliquors can be used together in the method. In such case, the step of fatliquoring comprises a first step of fatliquoring with an anionic fatliquor, and a second step of fatliquoring with a cationic fatliquor, and the step of pickling is done between the first and second fatliquoring steps. Thus, another alternative combination of steps in the method is: fatliquoring with an anionic fatliquor, pickling, fatliquoring with a cationic fatliquor and drying, in that order.

### Pickling

Pickling solutions conventionally used in the tanning industry comprise an aqueous solution of sodium chloride and acid. Such conventional pickling solutions can be used in the method of the invention.

Pickling solutions that are preferred for use in the invention comprise aqueous solutions of formic acid, sulphuric acid and either sodium chloride, potassium chloride or a combination of both salts. The salt content is in the range of 3 to 15 weight % and the formic acid and sulphuric acid content each in the range of 0.5 to 5 weight % (all relative to the weight of the hide). One preferred pickling solution, referred to herein as “standard acid,” comprises 7 weight % sodium chloride, 1 weight % formic acid and 1 weight % sulphuric acid. Another preferred pickling solution, referred to herein as “double acid,” comprises 7 weight % sodium chloride, 2 weight % formic acid and 2 weight % sulphuric acid.

In order to reduce the amount of sodium chloride in the pickling solution, all or part of it can be replaced by potassium chloride. Thus, another preferred pickling solution comprises 3.5 weight % sodium chloride, 3.5 weight % potassium chloride, 2 weight % formic acid and 2 weight % sulphuric acid.

### Drying

The step of drying, as used in the method of the invention, is carried for two purposes. One is to reduce the weight of the treated hide. Since the treated hides are typically shipped elsewhere for tanning, reducing the weight lowers the shipping cost. The second reason is to aid in the preservation of the hides, as reducing the moisture content of the treated hides lessens their susceptibility to the growth of bacteria, molds and fungi. It will be understood that the treated hides do not need to be dried to a state of complete dryness. In the specification and claims, “drying” means reducing the moisture content to a desired level. The moisture level of the dried hides is typically up to about 25 weight %. Preferred moisture levels are in the range of 5 to 25 weight %, more preferably 10 to 15 weight %.

Drying can be carried out in several ways. It is possible to dry the hides simply by air drying, hanging the treated hides to dry in the open air until the desired moisture level is attained. For faster processing, however, mechanical drying means are employed. One means of drying is sammying, in which a wet hide is machine-rung between felt-covered rollers. Another means of drying is vacuum drying, in which a hide is placed in a drying chamber under reduced air pressure. Another is toggle drying, in which hides are stretched on a rack with toggles at their edges and passed through a heating chamber.

Another drying method is solvent drying, in which a hide is treated with an organic solvent that drives out the water. The hides are immersed in the solvent for a time period typically in the range of 15 minutes to 4 hours. Various organic solvents may be used for this purpose. A preferred solvent comprises a solution of aliphatic hydrocarbons, fatty alcohol ethoxylate, glycol ether, n-methyl-2-pyrrolidone and orange terpenes. The solvents can be used in their concentrated form or diluted with water.

The step of drying can comprise a combination of these steps. For example, a first step of sammying can be followed by one or more of solvent drying, vacuum drying, toggle drying and air drying. Another combination is a first step of solvent drying, followed by sammying, followed by one or more of vacuum drying, toggle drying and air drying.

### Splitting

It is common in the industry to split hides during the leather making process, producing a grain split and a bottom split that are each further processed to produce leather having the desired characteristics. Splitting is an optional step in the method of the present invention. It would be done during the preliminary steps, prior to bating. Typically, it would be done after unhairing and prior to deliming.

### Staking

Staking is commonly done to hides during conventional leather making processes. It consists of mechanically flexing the hide in order to improve its pliability. The step of staking is an optional step in the method of the present invention. It would typically be done after the step of drying.

### EXAMPLES

Raw, fresh cowhides weighing between 31 and 35 kg were subjected to the preliminary steps of washing, fleshing, liming, unhairing, splitting, deliming and bating. These prepared hides were then processed as described in the following Examples. Weight percentages stated in the Examples are based on the weight of the split hide being treated, being about 16 to 18 kg.

### Example 1

Hides were processed by fatliquoring with anionic fatliquor for 90 minutes at pH 8 and a temperature of 30 degrees C., then pickled, sammied, dried by means of toggle drying and staked. The following combinations of weight percentages of anionic fatliquor and the type of pickling aqueous solution were used.

| | Weight % Anionic | |
|---|---|---|
| Sample Number | Fatliquor | Pickling Solution |
| 1 | 2 | standard acid |
| 2 | 5 | standard acid |
| 3 | 5 | double acid |
| 4 | 10 | standard acid |
| 5 | 10 | double acid |
| 6 | 15 | standard acid |
| 7 | 2 | standard acid with |
| | | mixed salt¹ |
| 8 | 2 | double acid with |
| | | mixed salt² |
| 9 | 5 | standard acid with |
| | | mixed salt¹ |
| 10 | 5 | double acid with |
| | | mixed salt² |
| 11 | 10 | standard acid with |
| | | mixed salt¹ |
| 12 | 10 | double acid with |
| | | mixed salt² |
| 13 | 15 | standard acid with |
| | | mixed salt¹ |

¹3.5 weight % sodium chloride, 3.5 weight % potassium chloride, 1 weight % formic acid, 1 weight % sulphuric acid.
²3.5 weight % sodium chloride, 3.5 weight % potassium chloride, 2 weight % formic acid, 2 weight % sulphuric acid.

### Example 2

Hides were processed by pickling, then fatliquoring with cationic fatliquor for 90 minutes at pH 2 and a temperature of 25 degrees C., then sammied, dried by means of toggle drying and staked. The following combinations of weight percentages of cationic fatliquor, and the type of pickling aqueous solutions were used.

| | Weight % Cationic | |
|---|---|---|
| Sample Number | Fatliquor | Pickling Solution |
| 1 | 5 | standard acid |
| 2 | 5 | double acid |
| 3 | 10 | standard acid |
| 4 | 10 | double acid |
| 5 | 5 | standard acid with |
| | | mixed salt¹ |
| 6 | 5 | double acid with |
| | | mixed salt² |
| 7 | 10 | standard acid with |
| | | mixed salt¹ |
| 8 | 10 | double acid with |
| | | mixed salt² |

¹3.5 weight % sodium chloride, 3.5 weight % potassium chloride, 1 weight % formic acid, 1 weight % sulphuric acid.
²3.5 weight % sodium chloride, 3.5 weight % potassium chloride, 2 weight % formic acid, 2 weight % sulphuric acid.

### Example 3

Hides were prepared as in Example 1, except that after the step of sammying, the hides were subjected to solvent drying, then sammying and drying by means of toggle drying and finally staking. The organic solvent was used at either full strength or half strength, meaning diluted 50% with water. The following combinations of drying parameters were used.

| | | Solvent Application |
|---|---|---|
| Sample Number | Solvent Strength | Time (minutes) |
| 1 | full | 5 |
| 2 | full | 15 |
| 3 | half | 15 |
| 4 | half | 30 |

### Example 4

Hides were processed by fatliquoring with anionic fatliquor for 90 minutes at pH 8 and a temperature of 30 degrees C., then pickling, then fatliquoring with cationic fatliquor for 90 minutes at pH 2 and a temperature of 25 degrees C., then sammied, toggle dried and staked. The following combinations of parameters were used.

| | Weight % | Weight % | |
|---|---|---|---|
| | Anionic | Cationic | Pickling |
| Sample Number | Fatliquor | Fatliquor | Solution |
| 1 | 5 | 5 | standard acid |
| 2 | 5 | 5 | double acid |

### Example 5

Hides were processed as in the previous Examples using fatliquor levels below 1% and above 15%. The results were not satisfactory. Processing with the low levels of fatliquor produced hides that were stiff and hard with poor handle. Processing with the high levels of fatliquor produced hides that were excessively greasy.

### Conclusions from the Examples

The hides processed in accordance with Examples 1 to 4 were dry, flexible and were easily rehydrated for tanning with chromium sulphate, vegetable tannins or synthetic tanning agents. Hides processed in accordance with Examples 1 to 4 were stored for six months with varying humidity. No signs of spoilage, fungal growth or mold growth were visible. The hides rehydrated within 3 to 24 hours.

Although the invention has been described in terms of various embodiments, it is not intended that the invention be limited to those embodiments. Various modifications within the scope of the invention will be apparent to those skilled in the art. The scope of the invention is defined by the claims that follow.

1. A method for preserving hides prior to tanning without salt-curing the hides, in which the hides are subjected to preliminary steps comprising washing, fleshing, liming, unhairing, deliming and bating, characterized in that the method comprises the steps, after the step of bating, of fatliquoring, pickling and lastly drying.

2. A method according to claim 1, wherein the step of fatliquoring is done before the step of pickling.

3. A method according to claim 2, where the step of fatliquoring is done with an anionic fatliquor.

4. A method according to claim 1, wherein the step of fatliquoring is done after the step of pickling.

5. A method according to claim 4, wherein the step of fatliquoring is done with a cationic fatliquor.

6. A method according to claim 1, wherein the step of fatliquoring comprises a first step of fatliquoring with a solution of an anionic fatliquor and a second step of fatliquoring with a solution of cationic fatliquor, and the step of pickling is done between said first step and said second step.

7. A method according to claim 1, further comprising, after the step of drying, the step of staking.

8. A method according to claim 1, further comprising, after the steps of fatliquoring and pickling, the step of sammying and after the step of drying, the step of staking.

9. A method according to claim 1, wherein said preliminary steps further comprise the step of splitting prior to the step of bating.

10. A method according to claim 1, wherein said step of drying comprises:
(a) sammying; and
(b) one of solvent drying, vacuum drying, toggle drying and air drying.

11. A method according to claim 3, wherein said anionic fatliquor is 1 to 15% by weight relative to the weight of said hide being fatliquored.

12. A method according to claim 5, wherein said cationic fatliquor is 1 to 15% by weight relative to the weight of said hide being fatliquored.

13. A method according to claim 1, wherein said step of pickling is done with a pickling solution comprising formic acid, sulfuric acid and one of sodium chloride or potassium chloride.

14. A method according to claim 1, wherein said step of pickling is done with a pickling solution comprising formic acid, sulfuric acid, sodium chloride and potassium chloride.

15. A method according to claim 13, wherein said pickling solution comprises said formic acid in an amount that is 0.5 to 5 wt % relative to the weight of said hide being pickled.

16. A method according to claim 13, wherein said pickling solution comprises said sulfuric acid in an amount that is 0.5 to 5 wt % relative to the weight of said hide being pickled.

17. A method according to anyone of claim 13, wherein said pickling solution comprises sodium chloride or potassium chloride in an amount that is 3 to 15 wt % relative to the weight of said hide being pickled.

18. A method according to claim 14, wherein said pickling solution comprises said sodium chloride and said potassium chloride each in an amount that is 1.5 to 7.5 wt % relative to the weight of said hide being pickled.

19. A method according to claim 10, wherein said solvent drying is done using a solvent comprising:
(a) an aliphatic hydrocarbon;
(b) a fatty alcohol ethoxylate;
(c) a glycol ether;
(d) n-methyl-2-pyrrolidone; and
(e) an orange terpene.

20. A method according to claim 1, wherein said step of drying comprises:
(a) solvent drying;
(b) sammying; and
(c) one of vacuum drying, toggle drying and air drying.

21. A preserved, fatliquored, dried, untanned, non-salt-cured hide.

22. A hide according to claim 21, wherein the hide is pickled.

23. A hide according to claim 21, wherein the hide is unhaired.

24. A preserved, fatliquored, pickled, dried, untanned hide made according to the method of claim 1.

25. A hide according to claim 21, wherein the hide is dried subsequent to being fatliquored.

26. A hide according to claim 22, wherein the hide is dried subsequent to being fatliquored and pickled.

27. A hide according to claim 21, wherein the hide is a cowhide.

28. A method according to claim 1, wherein the hide is a cowhide.
